(19) United States
(12) Patent Application Publication
(10) Pub. No.: US 2003/0140455 A1
(43) Pub. Date: Jul. 31, 2003

(54) Provisional door-stop device for vehicle doors

(76) Inventor: Vittorio Audisio, Milano (IT)

Correspondence Address: TRASK BRITT, P.O. BOX 2550, SALT LAKE CITY, UT, 84110, US

(21) Appl. No.: 10/157,341

(22) Filed: May 29, 2002

(30) Foreign Application Priority Data
Jan. 28, 2002 (EP) 02425033.4

(51) Int. Cl. E05D 11/10

(52) U.S. Cl. 16/334

(57) ABSTRACT

A provisional door-stop device designed to be installed on a hinge for a vehicle door to withhold the door in a closed position and in an open position during the operations of assembly of the vehicle. The hinge (10) comprises a fixed hinge element (12) and a mobile hinge element (14), which are articulated together by means of a hinge pin (20), the mobile hinge element (14) being fixed to the hinge pin (20) by means of a screw (28) which is coaxial with the hinge axis (22). The provisional door-stop device (42) comprises a metal element forming a closed structure that includes:

a fixing portion (44) provided with a hole (52) for engagement by the aforesaid fixing screw (28);

two supporting portions (46) which extend from the fixing portion (44); and

a deformable portion (48) which extends between the ends of said supporting portions (46) and comprises a projecting portion (58) designed to pass over a portion (34) of the fixed hinge element (12) as a result of movement of the door from the open position to the closed position, and vice versa.

The present invention relates to a provisional door-stop device for vehicle doors, designed to be mounted on the hinge of a vehicle door to withhold the door in an open position or closed position during the step of assembly of the vehicle on the assembly line.

During the operations of assembly of vehicles on an assembly line provisional door-stop devices are used, which are removed at the end of vehicle assembly and replaced by definitive door-stop devices. Normally the definitive door-stop devices are not used during the sequence of vehicle assembly in order to prevent the definitive door-stop devices from getting damaged during painting of the car body. One solution currently adopted by some automobile manufacturers involves using, as provisional door-stop device, a device of the same type as the definitive door-stop device. The provisional door-stop device is installed on the car body before the latter is painted and is removed after the painting operations are completed and then replaced with a definitive door-stop device. The provisional door-stop devices are recovered since they are of the same type as the definitive ones and have a high cost. The recovery operation entails an operation of paint removal and transportation from one area of the assembly line to another. Taking into account the times necessary for the assembly and disassembly operations and the costs linked to re-use of the door-stop devices, this solution proves very burdensome for automobile manufacturers, also considering the fact that the provisional door-stop devices are subject to frequent breakages as a result of the repeated cycles of assembly, painting, disassembly and paint removal.

The purpose of the present invention is to provide a provisional door-stop device which is simple and of contained cost and which enables the aforesaid problems to be overcome.

According to the present invention, the above purpose is achieved by a provisional door-stop device having the characteristics forming the subject of claim 1.

According to the present invention, a disposable provisional door-stop device is provided that can be mounted directly on a bottom or top articulation hinge between the door and the body of the vehicle. This enables the operations of installation and removal to be carried out at the same time as installation and removal of the hinges, without introducing a separate operation of installation and removal of the provisional door-stop device. The device according to the present invention has a very simple and economical structure and can be thrown away after use, so eliminating the operations entailed in re-use (paint removal, checking and transportation). The use of a provisional door-stop device according to the present invention enables the automobile manufacturer to obtain a saving on costs for the use of provisional door-stop devices, as well as a simplification in handling said components.

Further characteristics and advantages of the present invention will emerge clearly from the ensuing detailed description, which is provided purely by way of non-limiting example, with reference to the attached drawings, in which:

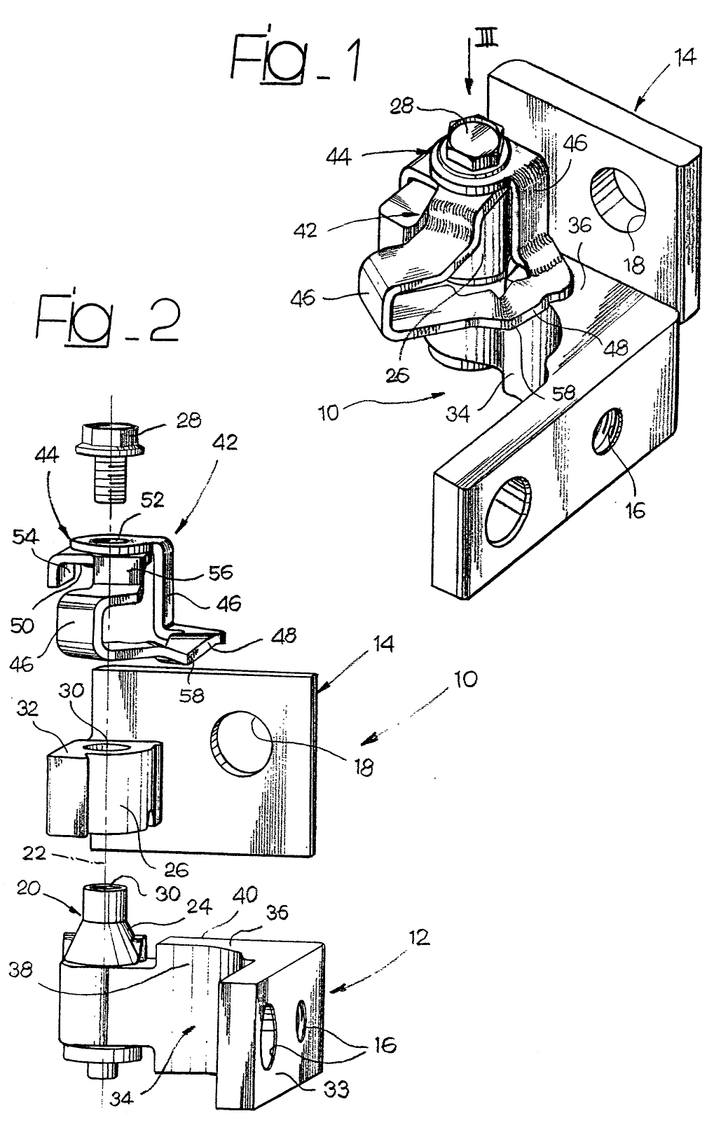

FIG. 1 is a perspective view of a hinge for vehicle doors provided with a provisional door-stop device according to the present invention;

FIG. 2 is an exploded perspective view of the hinge of FIG. 1;

FIG. 3 is a plan view according to the arrow III of FIG. 1; and

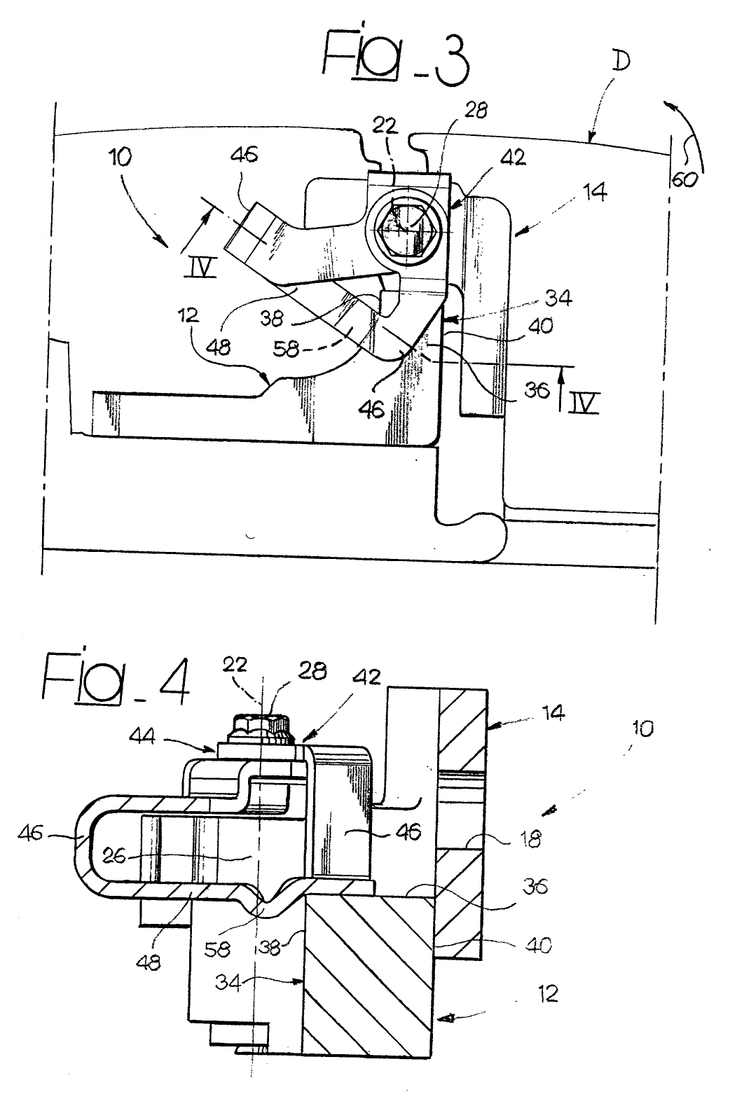

FIG. 4 is a cross-sectional view according to the lines IV-IV of FIG. 3.

With reference to the figures, number 10 designates a hinge for vehicle doors of a type in itself known, comprising a fixed hinge element 12 designed to be fixed to the body of the vehicle, and a mobile hinge element 14 designed to be fixed to the door. The two hinge elements are provided with respective fixing holes 16, 18. A hinge pin 20 is carried by the fixed hinge element 12 in such a way that it can turn about its own longitudinal axis 22. The hinge pin 20 is constrained in an axial direction to the fixed hinge element 12 and has a fixing portion 24 (see FIG. 2) which is inserted into a seat formed in a portion 26 of the mobile hinge element 14. The hinge pin 20 is fixed to the mobile hinge element 14 by means of a screw 28 which has an axis parallel to the longitudinal axis 22 and engages a threaded hole 30 of the hinge pin 20. The portion 26 of the mobile hinge element 14 has a hole 30 for passage of the threaded shank of the screw 28, and a top resting surface 32.

The fixed hinge element 12 is basically L-shaped, with a first part 33 bearing the fixing holes 16 and a second part 34 carrying the seat for the hinge pin 20. The second part 34 has a top surface 36 and two side walls 38, 40.

The reference number 42 designates a provisional door-stop device according to the present invention. The device 42 basically consists of a strip of metal material with high elasticity, such as spring steel. The metal strip is bent in such a way as to form a closed structure including a fixing portion 44, two supporting portions 46, which extend downwards starting from the fixing portion 44, and a deformable portion 48, which extends between the bottom ends of the two supporting portions 46.

The fixing portion 44 is shaped so as to mate with the portion 26 of the mobile hinge element 14 in such a way as to be fixed in rotation with respect to the latter and to enable installation on the hinge 10 and removal therefrom of the door-stop device 42 in a fast way. The fixing portion 44 has a bottom resting surface 50 which rests on the top resting surface 32 of the portion 26 and has a hole 52 through which the threaded shank of the screw 28 extends. Fixing of the provisional door-stop device 42 to the mobile hinge element 14 has to withstand somewhat high torques, for instance of the order of 30 N*m. This is obtained by providing two or more retention surfaces 54, 56 in the fixing portion 44, the said retention surfaces 54, 56 resting against corresponding surfaces of the portion 26 of the mobile hinge element 14. The retention walls 54, 56 establish a shape fit with the portion 26 against non-coplanar surfaces of the portion 26 so as to provide a fit similar to the one that is obtained between a spanner and a nut. The supporting portions 46 extend towards the bottom of the fixing portion 44 in directions that are substantially parallel to the axis of rotation 22 of the hinge 10 and have dimensions chosen so as to maintain the deformable portion 48 in a pre-set position with respect to the top surface 36 of the fixed hinge element 12.

The deformable portion 48 comprises a portion 58 projecting downwards. In the configuration in which the provisional door-stop device 42 is mounted on the hinge, the projecting portion 58 protrudes downwards with respect to the plane of the top surface 36 of the fixed hinge element 12 (FIG. 4). The projecting portion 58 has an arched profile and is radiused to the bottom surface of the remaining part of the deformable portion 48.

There now follows a description of the operation of the door-stop device according to the present invention. The hinge 10 to which the door-stop device 42 is designed to be fitted is a hinge of the removable type, in which the mobile hinge element 14 is fitted to the hinge pin 20 by means of the screw 28 and can be separated from the fixed hinge element 12 after removal of the screw 28. During assembly of the vehicle, the hinge 10 is supplied to the assembly line in the assembled configuration illustrated in FIG. 1, complete with the provisional door-stop device 42. On the assembly line, the hinge is mounted on the vehicle, with the fixed hinge element 12 which is fixed to the body and the mobile hinge element 14 which is fixed to the door. The rough body, complete with doors, undergoes various processing steps, including a painting step. During these equipping operations, the provisional door-stop device 42 has the purpose of withholding the door in a stable way in an open position and in a closed position. In this connection, it should be pointed out that each door of the vehicle is connected to the body by means of a pair of hinges with hinge axes that are aligned with one another, and it is sufficient to provide a door-stop device 42 for only one of the two door hinges. In the configuration illustrated in FIG. 3, the door of the vehicle, designated by D, is in a closed configuration, and the projecting portion 58 is on one first side of the portion 34 of the fixed hinge element 12. More precisely, in this configuration the projecting portion 58 is on the side of the face 38 of the portion 34, i.e., the face that faces the part 33 of the L-shaped section of the fixed hinge element 12. When the door D is opened, it rotates with respect to the hinge axis 22 in the direction indicated by the arrow 60 in FIG. 3. To perform this rotation, the projecting portion 58 has to move upwards on the top surface 36 of the fixed hinge element 12, and to do so produces an elastic deformation of the deformable portion 48. The supporting portions 46, located at the two ends of the deformable portion 48, behave basically as undeformable uprights, whereby the entire deformation necessary for enabling the projecting portion 48 to move upwards on the top surface 36 is provided by a bending of the plate that forms the deformable portion 48. As the door D continues to rotate towards the open position, when the projecting portion 58 reaches the end of the top surface 36 it snaps back into its undeformed position, setting itself on the face 40 of the fixed hinge element 12. In this configuration, the provisional door-stop device 42 withholds the door D in the open position. It will be understood that, in order to open or close the door starting from the configuration of door open or of door closed, it is necessary to apply a pre-set torque on the hinge axis, the value of which depends upon the flexural stiffness of the deformable portion 48 and upon the size of the projecting portion 58. The device according to the present invention can be sized in such a way as to provide a resistant torque of approximately 30 N*m.

At the end of the painting step, the doors of the vehicle are removed to enable a more convenient access for equipping the interior of the passenger compartment. During removal of the doors, the provisional door-stop devices 42 are removed. When the doors are re-installed on the body, the mobile hinge element 14 of each hinge is mounted on the fixed hinge element 12 without the provisional door-stop device 42, and the door is provided with a definitive door-stop device, for example of the type including a tie-rod articulated to the body, which can slide between a pair of rollers elastically pushed against one another and carried by a retainer structure fixed to the door of the vehicle.

As compared to a traditional solution which envisages the use of re-usable provisional door-stop devices of a type similar to the definitive door-stop devices, the solution according to the present invention affords the advantage of doing away with the operations of installation and removal of the provisional door-stop device and further enables elimination of the operations of recovery and transportation of the door-stop device, given that this device is disposable on account of its low cost.

The closed structure of the device according to the present invention enables a device to be obtained which has a sufficiently high resistant torque and which is provided with a good fatigue strength, sufficient for temporary use (approximately 50 operations of opening and closing of the vehicle door).

1. A provisional door-stop device designed to be installed on a hinge for a vehicle door to withhold the door in a closed position and in an open position during the operations of assembly of the vehicle, in which the hinge comprises a fixed hinge element and a mobile hinge element articulated together by means of a hinge pin, and in which the mobile hinge element is fixed to the hinge pin by means of a screw that is coaxial with the hinge axis, the provisional door-stop device comprising a metal element forming a closed structure, which includes:
a fixing portion provided with a hole for engagement by the aforesaid fixing screw;
two supporting portions which extend from the fixing portion; and
a deformable portion which extends between the ends of said supporting portions and comprises a projecting portion designed to pass over a portion of the fixed hinge element as a result of movement of the door from the open position to the closed position, and vice versa.

2. The device according to claim 1, wherein the said fixing portion has surfaces that establish a shape fit with a part of the mobile hinge element.

3. The device according to claim 1, wherein the said projecting portion has an arched shape and is radiused to the remaining part of the deformable portion.

4. The device according to claim 1, characterized in that it is obtained by bending, starting from a strip of spring steel.
